(19) United States
(12) Patent Application Publication
(10) Pub. No.: US 2010/0253199 A1
(43) Pub. Date: Oct. 7, 2010

(54) LED LIGHTING TUBE

(75) Inventors: Kun-Jung Chang, Kaohsiung County (TW); Ching-Yuan Juan, Kaohsiung County (TW); Kuo-Chun Lin, Kaohsiung County (TW); Ching-Huang Juan, Kaohsiung County (TW)

Correspondence Address: Ching-Ling Huang, 5597 NW 127th Ter, Portland, OR, 97229, US

(73) Assignee: LI-HONG TECHNOLOGICAL CO., LTD., Kaohsiung County (TW)

(21) Appl. No.: 12/416,153

(22) Filed: Apr. 1, 2009

(51) Int. Cl. H01J 61/52

(52) U.S. Cl. 313/11

(57) ABSTRACT

The LED lighting tube of the present invention utilizes a tubular heat dispersing structure and arranges the LED module in a light-tube manner, characterized in that the tubular heat dispersing structure can produce the airflow to increase the heat dispersing effect, and also, the closed structure thereof can prevent dust accumulation, so as to protect the LED module and extend the lifetime of the LED module. Besides, the present invention also employs plural electric controllers to control LED bulbs in multiple LED modules so as to achieve a section control of LED bulbs of different positions or different colors and satisfy multiple illumination requirements.

### FIELD OF THE INVENTION

The present invention is related to an LED lighting tube, and more particularly to an LED lighting tube which utilizes a tubular heat dispersing structure and an LED module to provide great heat-dispersing property and section control.

### BACKGROUND OF THE INVENTION

Please refer to FIG. 1. The conventional LED lighting tube 1 utilizes the LED module owing to the properties of power-saving and high brightness. However, since the LED module 11 will generate a lot of heat, a heat dispersing set 12 has to be mounted thereon.

The heat dispersing set 12 mounted on the LED lighting tube 1 utilizes heat dispersing fins 121 to increase the contact area with the air so as to improve heat dispersing. Although the heat dispersing fins 121 can increase the air contact area, they can not guide the convection of the heated air, and plus, because the distance between the heat dispersing fins 121 and the reflector 2 is too short, the heated air will accumulate around the heat dispersing fins 121 and the reflector 2, so that the heat dispersing effect is significantly reduced.

Moreover, since the heat dispersing fins 121 employ an open structure, they are easily covered with dust 3, so as to reduce or even lose the heat dispersing efficiency, and further, this situation might also cause a bake effect to reduce the lifetime of the LED module 11.

Therefore, obviously, the conventional LED lighting tube structure is disadvantageous that:

1. The open heat dispersing fins which can not guide the convection of the heated air might not achieve a great heat dispersing effect.

2. The heat dispersing fins are easily covered with dust to lose efficacy, and even, the lifetime of the LED module might therefore be reduced.

### SUMMARY OF THE INVENTION

The object of the present invention is to overcome the defective heat dispersing structure of the conventional LED lighting tube, by employing a tubular heat dispersing structure which can increase the heat dispersing efficiency and also extend the lifetime of LED lighting tube.

For achieving the object described above, the present invention provides an LED lighting tube including a tubular heat dispersing structure, an LED module, two tube supporting bases, an electric controller and a lampshade, wherein the tubular heat dispersing structure and the LED module are both disclosed in the applicant's patent applications, and the present invention combines the advantages of both.

In the invention, the tubular heat dispersing structure is used for heat dispersing. The tubular heat dispersing structure includes plural hollow tube bodies and a heat conductive seat located at the bottom thereof, wherein planes and slants are formed at the bottom of the heat conductive seat for fixing the LED module or other geometric planes according to LED modules, and plural slots are mounted on the tube body for ventilation and improvement of heat dispersing effect. The LED module is fixed on and closely attached to the heat conductive seat at the lower side of the tubular heat dispersing structure, so that the heat can be conducted to the tubular heat dispersing structure. The two tube supporting bases are hollow cylindrical chambers located at two ends of the tubular heat dispersing structure and are respectively assembled with a sealing cover having a conductor, which acts as the electric connection point from the interior to the exterior of the sealing cover. The electric controller is located inside the hollow chamber of the tube supporting base and is respectively electrically connected with the conductor and the LED module.

The tubular heat dispersing structure of the present invention is a closed structure which will not be covered with the dust, and the heat dispersing effect can be enhanced by the airflow produced in the tubular structure. The LED module is closely attached to the tubular heat dispersing structure to speed up the heat transmission from the LED module to the heat dispersing structure so as to enhance the heat dispersing efficiency, and it also can be implemented to install plural LED modules according to different requirements. The electric controller is electrically connected with the conductor and the LED module, and according to different demands, the LED bulbs on the same LED module or different LED modules can be controlled by the electric controller in a grouping or integrated way.

Moreover, according to the real illumination requirement, the number of the LED module can be increased, and plural LED modules can be fixed and attached to different geometric planes of the heat conductive seat of the tubular heat dispersing structure, so as to improve the illumination effect.

In view of above, the present invention is advantageous that:

1. The LED lighting tube of the present invention utilizes the tubular heat dispersing structure which is a closed structure so that the dust will not easily enter the heat dispersing tube.

2. The LED lighting tube of the present invention can cooperate with plural electric controllers to control the LED module in section and control the LED bulbs in the same LED lighting tube in a grouping way.

3. The LED lighting tube of the present invention can have one or more LED modules with LED bulbs mounted therein for satisfying different illumination requirements.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a sectional view showing the conventional LED lighting tube;

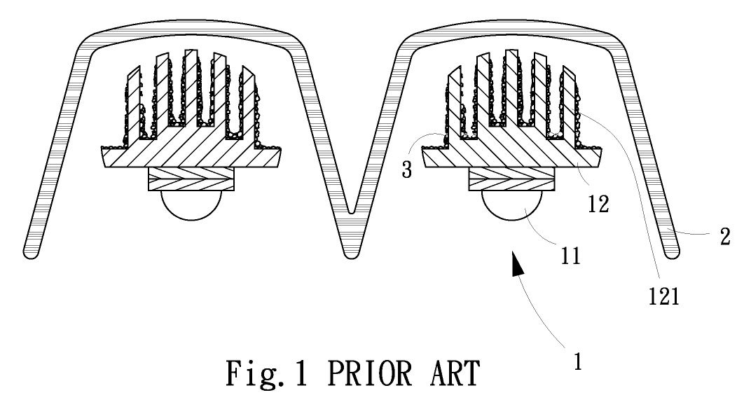

FIG. 2 is a three dimensional drawing showing the present invention;

FIG. 3 is a three dimensional drawing showing the decomposition of the present invention;

FIG. 4 is a three dimensional drawing showing the section of the tubular heat dispersing structure of the present invention;

FIG. 5 is a sectional view showing the present invention in a preferred embodiment;

FIG. 6 is a three dimensional drawing showing the decomposition of the preferred embodiment;

FIG. 7 is a three dimensional drawing showing the decomposition of another embodiment of the present invention; and

FIG. 8 is a schematic view showing the present invention with a section control in another embodiment.

### DESCRIPTION OF THE PREFERRED EMBODIMENT

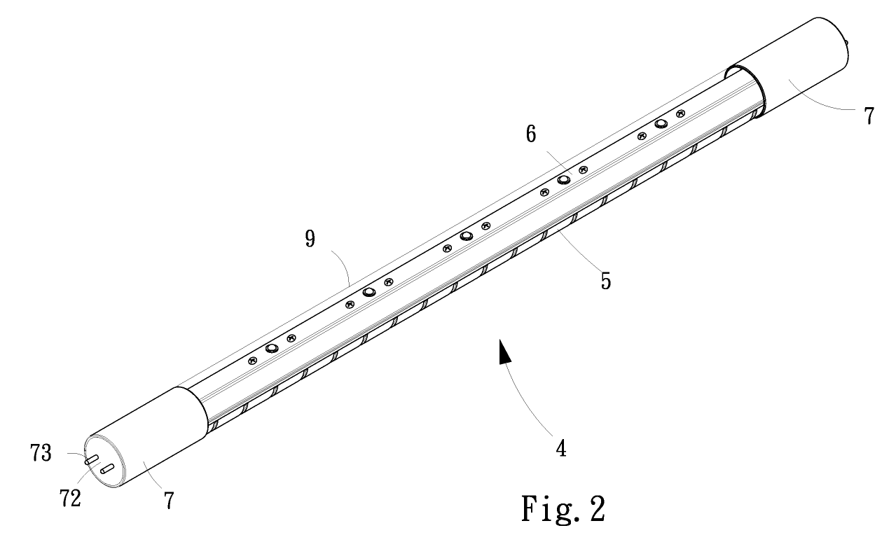

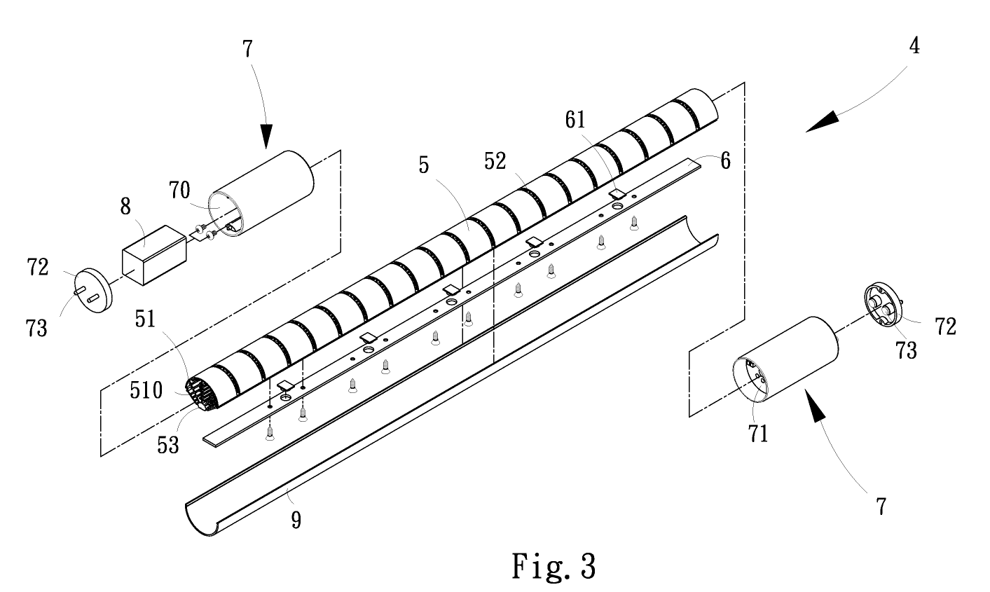

Please refer to FIG. 2 and FIG. 3 which show an LED lighting tube 4 including a tubular heat dispersing structure 5, an LED module 6, two tube supporting bases 7, an electric controller 8 and a lampshade 9.

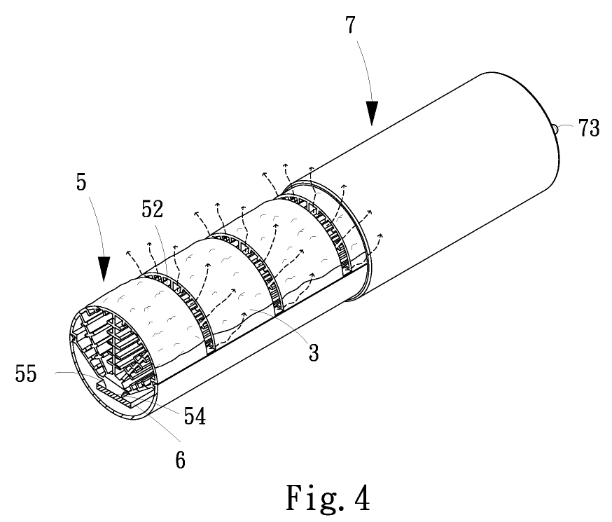

Please refer to FIG. 3 and FIG. 4. The tubular heat dispersing structure 5 includes plural hollow tube bodies 51 with openings 510 at two ends, plural slots 52 mounted on the tube bodies for ventilation, and a heat conductive seat 53 located at the bottom thereof, wherein a plane 54 is formed at the bottom of the heat conductive seat 53 with slants 55 at two sides thereof for fixing the LED module 6, and for mounting multiple LED modules 6, multiple heat conductive seats 53 can be installed.

The function of the tubular heat dispersing structure 5 is that, first, the heat is quickly conducted to the hollow tube body 51, then when the air in the tube body 51 is heated, the airflow will be produced, and when passing through the slots 52, the airflow will flows out of the tube body 51. Here, because the tubular heat dispersing structure 5 is a closed structure which disperses the heat by air flowing, even the tubular dispersing structure 5 is covered with dust 3, the heat dispersing effect will not be influenced.

The LED module 6 which includes one or more electrically connected LED bulbs 61 is fixed to the plane 54 at the bottom of the heat conductive seat 53 at the lower side of the tubular heat dispersing structure 5 by fixing elements, so that the LED module is attached to the plane 54 of the heat conductive seat 53 of the tubular heat dispersing structure 5.

The two tube supporting bases 7 are respectively constructed by a hollow cylindrical chamber 70 with a fixing socket 71 mounted therein, and by fixing elements which pass through the fixing sockets 71, the two tube supporting bases are fixed at the two end openings 510 of the tubular heat dispersing structure 5. The outer side of the hollow chamber 70 is assembled with a sealing cover 72 having a conductor 73, which acts as the electric connection point from the interior to the exterior of the sealing cover 72.

The electric controller 8 is mounted inside the hollow chamber 70 of the tube supporting base 7 and is electrically connected with the conductor 73 and the LED module 6.

The lampshade 9 is located below the tubular heat dispersing structure 5 and fixedly mounted between two tube supporting bases 7.

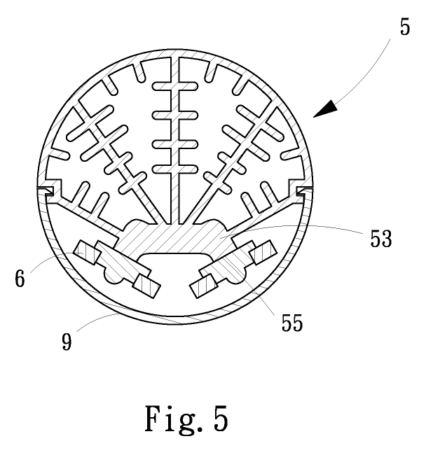

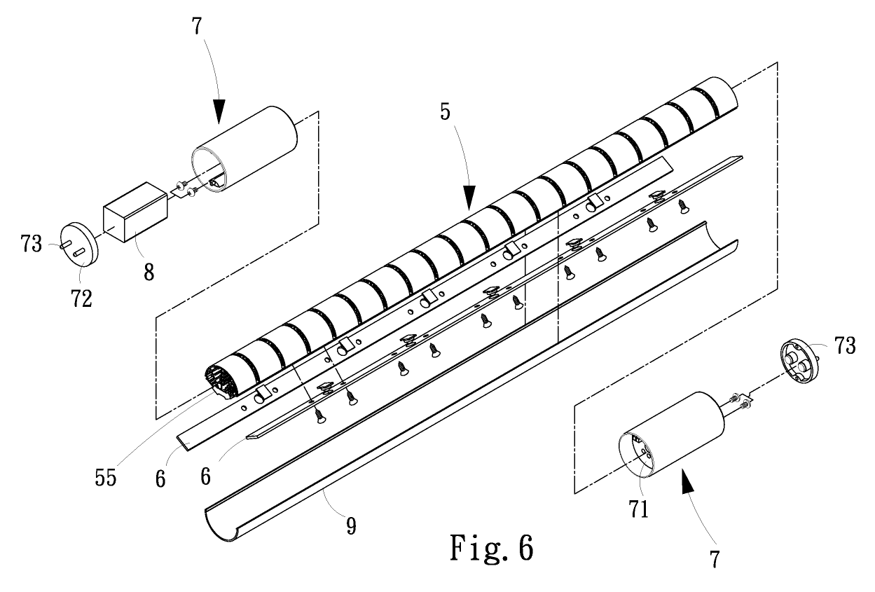

Please refer to FIG. 5 and FIG. 6 which show a preferred embodiment of the present invention. Here, an electric controller 8 controls plural LED modules 6 (in this embodiment, two LED modules 6), and the two LED modules 6 are respectively mounted on the slants 55 or other geometric planes of the heat conductive seat 53, so as to provide different angles of illumination and increase the brightness.

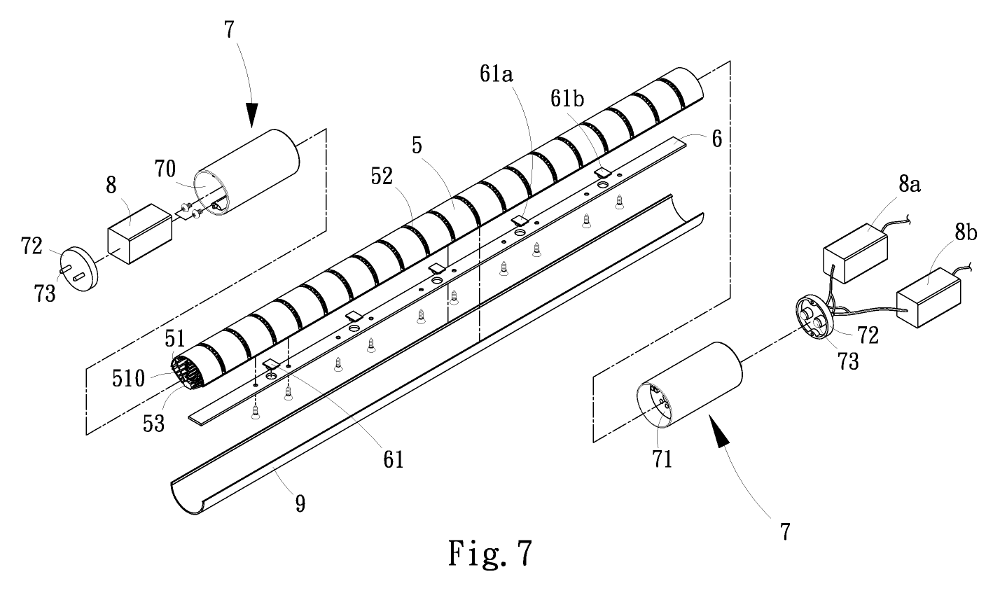

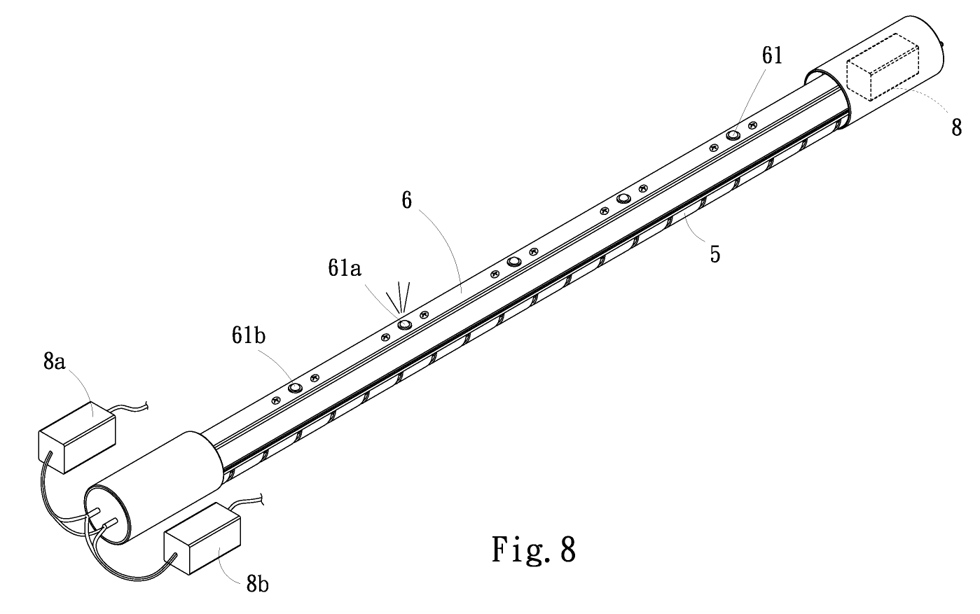

Furthermore, as shown in FIG. 7 and FIG. 8, in another embodiment, plural electric controllers 8, 8a, 8b are respectively located in the tube supporting bases 7 and outside the tube supporting bases 7 (here, two electric controllers 8a, 8b are located outside the tube supporting bases 7). Through the electrical connection, from the outside, the electric controllers 8a, 8b can respectively control the LED bulbs 61a, 61b, so that a section control or a synchronized and integrated control of LED bulbs 61, 61a, 61b can be achieved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED lighting tube, comprising a tubular heat dispersing structure, an LED module, two tube supporting bases, an electric controller and a lampshade, wherein:
the tubular heat dispersing structure includes plural hollow tube bodies with openings at two ends thereof and a heat conductive seat located at the bottom thereof;
the LED module includes one or more electrically connected LED bulbs and is fixed to the heat conductive seat at the bottom of the tubular heat dispersing structure;
the two tube supporting bases are respectively constructed by a hollow cylindrical chamber with a fixing socket mounted therein, and the outer sides of the tube supporting bases are respectively assembled with a sealing cover having a conductor, which acts as an electric connection point from the interior to the exterior of the sealing cover;
the electric controller is mounted inside the hollow chamber of one of the tube supporting bases and is electrically connected with the conductor and the LED module; and
the lampshade is located below the tubular heat dispersing structure and fixedly mounted between the two tube supporting bases.

2. The LED lighting tube as claimed in claim 1, wherein the heat conductive seat located below the tubular heat dispersing structure is fixed with plural LED modules.

3. The LED lighting tube as claimed in claim 2, wherein the heat conductive seat includes plural planes, slants or other geometric planes for mounting the LED modules.

4. The LED lighting tube as claimed in claim 1, wherein the number of the electric controller is implemented to be plural for section control of LED bulbs of plural LED modules.

5. The LED lighting tube as claimed in claim 1, wherein the electric controller is implemented to locate outside the tube supporting bases, and through an electrical connection, the electric controller controls the LED bulbs of the LED module from the outside of the LED lighting tube.
